(19) United States
(12) Patent Application Publication
(10) Pub. No.: US 2022/0335172 A1
(43) Pub. Date: Oct. 20, 2022

(54) SYSTEM AND METHOD FOR AUTOMATICALLY GENERATING AN OPTIMIZED BUILDING FACADE DESIGN

(71) Applicant: Lendlease Digital IP Pty Limited, Barangaroo NSW (AU)

(72) Inventors: Ngoc Thang Ho, Wolli Creek NSW (AU); Robert Bruce Beson IV, Arcadia NSW (AU); Geoffrey Burton Bell, Brooklyn, NY (US); John David Cerone, Brooklyn, NY (US); Adamo Garritano, Toronto (CA); Scott Preston Overall, Brooklyn, NY (US); Christopher Robert Sharples, New York, NY (US)

(21) Appl. No.: 17/232,077

(22) Filed: Apr. 15, 2021

(51) Int. Cl. G06F 30/13; E04B 2/72; E04B 2/00; G06F 30/12; G06F 30/20

(52) U.S. Cl. CPC G06F 30/13; E04B 2/72; E04C 2/44; G06F 30/12; G06F 30/20

(57) ABSTRACT

The present approach automatically generates an optimized building façade design given a set of building design parameters including a specified interior layout. The generated building façade design comprises a set of MegaPanels that are then displayed to the building designer for review and facilitate customization as desired by the façade designer. Some or all of this process can then be repeated when building design parameters are changed thereby facilitating automated and iterative building façade design as differing design parameters and resulting optimized building façade designs are considered.

### FIELD OF THE INVENTION

The present invention relates generally to generating a building façade design.

### BACKGROUND OF THE INVENTION

The process of designing a building façade, which is the exterior side of a building, has traditionally been a slow, labored process. The process typically starts with a chosen building site or location along with some building design parameters such as building dimensions (e.g., width, or length if considered from the building edge or end), height and/or number of stories for a building with multiple stories, and defined interior spaces (e.g., living spaces, kitchens, bedrooms, bathrooms, etc.). A building façade designer must then specify walls, windows, doors, and any associated architectural and/or aesthetic features (e.g., balconies, awnings, etc.) for each portion of the building exterior, for each floor. As can be imagined, this can take some time, particularly if later design changes are to be made, and typically requires specialized knowledge of a professional building façade designer who must take into account a significant number of building design elements and factors.

Of course, this process of designing a building facade can be fairly straightforward when the specified building design parameters are themselves simple. For example, specifying a one story building of a limited length/width can be an almost trivial building façade design process. However, with a larger building (e.g., multiple floors, overall dimensions, etc.) and a greater number and variety of desired interior units, the building façade design process can become much more complex.

It is for this reason that building designers, who may use various design tools such as Computer-Aided Design and Computer-Aided Manufacturing (“CAD/CAM”) tools, still primarily follow an ad hoc, manual (i.e., mental) process of designing a building facade in order to meet all of the specified building design elements and provide an aesthetically appealing design. As can be imagined, such a manual process can take quite some time and is not easily or quickly revised should one wish to change some of the specified building design elements or consider alternative aesthetic choices. For example, after the building façade designer has painstakingly designed a building facade to meet the various specified building design elements and provide an aesthetically appealing facade, should a different design aesthetic be desired, then the building façade designer most likely will have to revisit many of the steps taken in the manual process in order to prepare a revised building facade, essentially starting over in the building façade design process, a costly and time-consuming endeavor.

This process of designing a building façade has changed somewhat in the modern age with the advent of prefabricated building façade panels. Such prefabricated building façade panels, which are manufactured at some central location before being shipped to the building site, are typically intended to cover some portion of a single floor of a building and already include some combination of doors, windows, and/or wall portions. Use of prefabricated building façade panels has increased in order to reduce construction time and expense. However, using such prefabricated panels typically limits flexibility in interior design layout, which must match the physical arrangement of the prefabricated building façade panels. Using such prefabricated panels also limits the flexibility in architectural features and aesthetics in building façade design because prefabricated building façade panels of the known art allow limited options for a building façade designer to make changes or additions to them.

What is needed, therefore, is an automated approach to generating a building facade design given a set of specified building design parameters. A further need is for such an automated approach to incorporate changes in the specified building parameters while continuing to generate a building façade design in a timely and cost-effective manner.

### SUMMARY OF THE INVENTION

One embodiment discloses a method for generating an optimized building façade design, the method comprising: generating, by a façade pixel generator module, a collection of façade pixels, wherein each façade pixel in the collection of façade pixels defines a set of façade components; and generating, by a megapanel generator module, a set of defined megapanels, wherein each defined megapanel in the set of defined megapanels comprises a different combination of the generated façade pixels.

In a further embodiment, the method comprises: displaying, by a display and customization module, the building façade design using the generated set of defined megapanels; receiving a user input specifying a change to the generated set of defined megapanels; and displaying, by the display and customization module, the building façade design using the generated set of defined megapanels incorporating the specified change to the generated set of defined megapanels.

In a still further embodiment of the method wherein generating, by the façade pixel generator module, a collection of façade pixels, wherein each façade pixel in the collection of façade pixels defines a set of façade components, comprises: obtaining a building façade boundary of the building for which the building façade design is being generated; dividing the façade boundary into façade frontages according to defined interior spaces of the building for which the building facade design is being generated; locating a façade pixel configuration for each façade frontage by searching a set of predefined façade pixel configurations and finding a matching façade pixel configuration for each of the façade frontages; instantiating each located façade pixel configuration for each façade frontage by adjusting, as needed, each façade pixel configuration to fit dimensions of the façade frontage according to the façade pixel configuration located for that façade pixel; and, arranging the instantiated façade pixels into a façade strip.

In a yet still further embodiment of the method wherein generating, by a megapanel generator module, a set of defined megapanels, wherein each defined megapanel in the set of defined megapanels comprises a different combination of the generated façade pixels, comprises: creating multiple groupings of megapanels wherein each megapanel comprises a set of multiple contiguous façade pixels; and selecting one megapanel grouping from the multiple megapanel groupings.

In a still yet further embodiment of the method wherein creating multiple groupings of megapanels is accomplished using a Subset Sum Problem approach.

In further yet still embodiment of the method wherein selecting one megapanel grouping from the multiple megapanel groupings is based on a calculated score for each of the multiple megapanel groupings.

Another embodiment discloses a system for generating an optimized building façade design, the system comprising; a façade pixel generator module configured to generate a collection of façade pixels, wherein each façade pixel in the collection of façade pixels defines a set of façade components; and a megapanel generator module configured to generate a set of defined megapanels, wherein each defined megapanel in the set of defined megapanels comprises a different combination of the generated façade pixels.

In a further embodiment, the system further comprises: a display and customization module, the display and customization module configured to display the building façade design using the generated set of defined megapanels; receive a user input specifying a change to the generated set of defined megapanels; and display the building façade design using the generated set of defined megapanels incorporating the specified change to the generated set of defined megapanels.

In a still further embodiment of the system, wherein the façade pixel generator module configured to generate a collection of façade pixels, wherein each façade pixel in the collection of façade pixels defines a set of façade components, is further configured to: obtain a building façade boundary of the building for which the building façade design is being generated; divide the façade boundary into façade frontages according to defined interior spaces of the building for which the building facade design is being generated; locate a façade pixel configuration for each façade frontage by searching a set of predefined façade pixel configurations and finding a matching façade pixel configuration for each of the façade frontages; instantiate each located façade pixel configuration for each façade frontage by adjusting, as needed, each façade pixel configuration to fit dimensions of the façade frontage according to the façade pixel configuration located for that façade pixel; and, arrange the instantiated façade pixels into a façade strip.

In a yet still further embodiment of the system, wherein the megapanel generator module configured to generate a set of defined megapanels, wherein each defined megapanel in the set of defined megapanels comprises a different combination of the generated façade pixels, is further configured to: create multiple groupings of megapanels wherein each megapanel comprises a set of multiple contiguous façade pixels; and select one megapanel grouping from the multiple megapanel groupings.

In a still yet further embodiment of the system, wherein the megapanel generator module configured to create multiple groupings of megapanels is configured to create the multiple groupings of megapanels using a Subset Sum Problem approach.

In a further yet still embodiment of the system, wherein the system further configured to select one megapanel grouping from the multiple megapanel groupings is further configured to make the selection based on a calculated score for each of the multiple megapanel groupings

### BRIEF DESCRIPTION OF THE DRAWINGS

FIG. 1 is a block diagram of a Façade Design Generation System according to one embodiment of the present approach.

FIG. 2 is a flowchart of a process of automatically generating a building façade design according to one embodiment of the present approach.

FIG. 3 is a flowchart of a more detailed example of generating a collection of Façade Pixels according to one embodiment of the present approach.

FIG. 4A is a table of Façade Pixel Configurations, configured as a default Façade design preset, according to one embodiment of the present approach.

FIG. 4B is a table showing an example set of façade components according to one embodiment of the present approach.

FIG. 5 is a flowchart of a more detailed example of generating Façade MegaPanels from Façade Pixels according to one embodiment of the present approach.

FIG. 6 is a flowchart of one method of grouping Façade Pixels into MegaPanels, referred to herein as a forward-checking approach, according to one embodiment of the present approach.

FIG. 7 is a flowchart of another method of grouping Façade Pixels into MegaPanels, referred to herein as a partitioning problem approach, according to one embodiment of the present approach.

FIG. 8 is a table of Façade Pixel Configurations, configured as an alternative Façade design preset, according to one embodiment of the present approach.

FIG. 9 is a flowchart of a method of identifying and scoring a set of unique Façade MegaPanels in a grouping of MegaPanels according to one embodiment.

### DETAILED DESCRIPTION OF THE INVENTION

A method and apparatus is disclosed herein for automatically generating an optimized building facade design given a set of building design parameters including a specified interior layout.

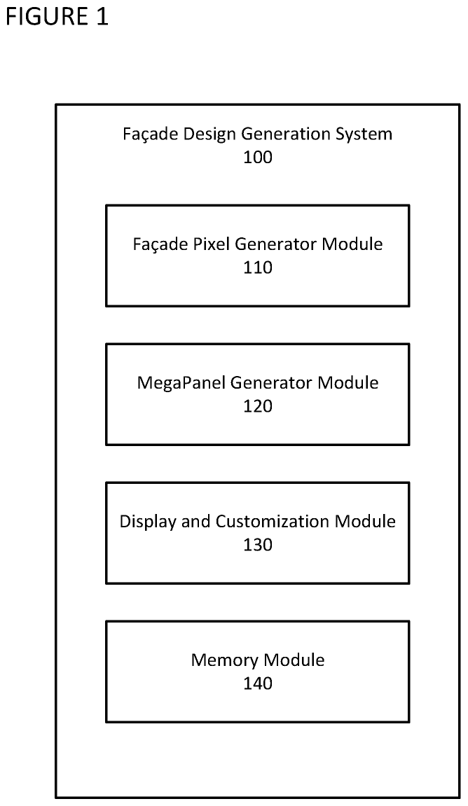

Referring now to the system diagram of FIG. 1, a Façade Design Generation System 100 is shown comprising a Façade Pixel Generator Module 110, a MegaPanel Generator Module 120, a Display and Customization Module 130, and a Memory Module 140. In one embodiment, Façade Design Generation System 100 is a computing system (e.g., a processor) in which Façade Pixel Generator Module 110, MegaPanel Generator Module 120, and Display and Customization Module 130 are computing modules (software, hardware or some combination thereof), and Memory Module 140 is operating and/or storage memory for use by the computing system.

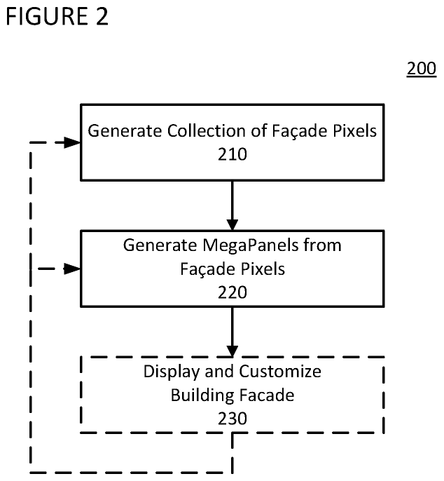

In one embodiment, as has been explained, generating a building façade design uses specified building parameters. Using this information, referring now to FIG. 2, a method 200 for automatically generating a building façade design is shown in flowchart form. With this method, in step 210, Façade Pixel Generator Module 110 of FIG. 1 generates a collection of Façade Pixels, which define different façade components or elements as explained further elsewhere herein. Continuing with this method, in step 220, MegaPanel Generator Module 120 of FIG. 1 generates a set of defined MegaPanels each MegaPanel comprising a different combination of the Façade Pixels generated in step 210. This method continues, in optional step 230, where Display and Customization Module 130 displays on a display device (not shown) to the façade designer the generated building façade design, which comprises the MegaPanels generated in step 220, and facilitates customization of the generated building façade design as desired.

It is to be understood that any or all of the above processes performed by the corresponding modules shown in the Façade Design Generation System 100 of FIG. 1, and the generated intermediate and/or final results of each, as well as the specified building parameters, can be stored in Memory Module 140 thereof, in a given implementation of the present approach.

It is to be further understood in light of the teachings herein that any part or all of the automated process of flowchart 200 can be repeated as needed to accommodate changes in the specified building parameters or design choices. Thus, after the system and method described herein has automatically generated one building facade design based on one set of specified building parameters, the system and method can automatically generate another building facade design based on a specified different set of building parameters and/or design choices. For example, the present approach can be used to automatically generate a different building facade design by specifying different design choices or a different façade design preset as described elsewhere herein. This means that the present automated approach can be performed iteratively as different building parameters and/or design choices are considered.

Such iterative processing of the present approach thus provides for essentially real-time generation and evaluation of different building façade designs using alternative building parameters without incurring the time and expense of the ad-hoc, non-optimized, manual building façade design approach presently known.

In accordance with one embodiment, a more detailed example of the present approach will now be explained.

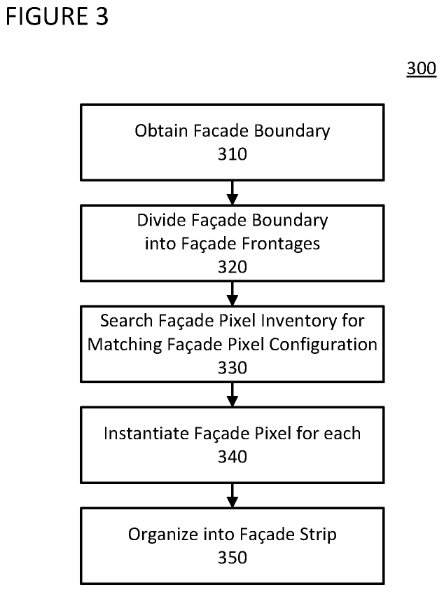

Referring now to FIG. 3, and in accordance with one embodiment, a more detailed example of Façade Pixel Generator Module 110 of FIG. 1 generating a collection of Façade Pixels according to step 210 of FIG. 2 is shown as process 300.

In step 310, a façade boundary is obtained. In particular, in one embodiment, Façade Pixel Generator Module 110 of FIG. 1 obtains the façade boundary (e.g., building length), which in one embodiment is the specified building parameter of building spine (e.g., a specified length of the building being designed) stored in Memory Module 140 of FIG. 1.

In step 320, the obtained Façade Boundary is divided into Façade Frontages according to defined interior spaces of the building. In particular, in one embodiment, Façade Pixel Generator Module 110 of FIG. 1 obtains interior space definitions (e.g., living spaces, bedrooms, bathrooms, kitchens, etc.) input by the designer and/or stored in Memory Module 140 of FIG. 1 (e.g., from a building floorplate layout designer and/or system) and using those interior space definitions divides the Façade Boundary into Façade Frontages accordingly.

Again, the Façade Frontages correspond to the defined interior spaces of the building. In one embodiment, the Façade Frontages are specified by length (e.g., length of the defined interior space) and type of defined interior space (e.g., living space, bedroom, bathroom, kitchen, etc.). For example, if the defined interior space is a kitchen then the Façade Frontage would be, for example, a length of 10 feet with a defined interior space of kitchen whereas if the defined interior space is a living space then the Façade Frontage would be, for example, a length of 20 foot with a defined interior space of living space.

In step 330, Façade Pixel Configurations that match the Façade Frontages are located. In particular, in one embodiment, Façade Pixel Generator Module 110 of FIG. 1 searches a database or other repository of Façade Pixel Configurations, which are predefined façade configurations as explained further elsewhere herein, to locate a match for each Façade Frontage from step 320. In one embodiment and as also explained further elsewhere herein, this matching is done according to a façade design preset, which is a defined group of Façade Pixel Configurations. In one embodiment, the façade design preset is either a default façade design preset of the Façade Design Generator System or is a façade design preset that is selected by the designer using the Façade Design Generator System.

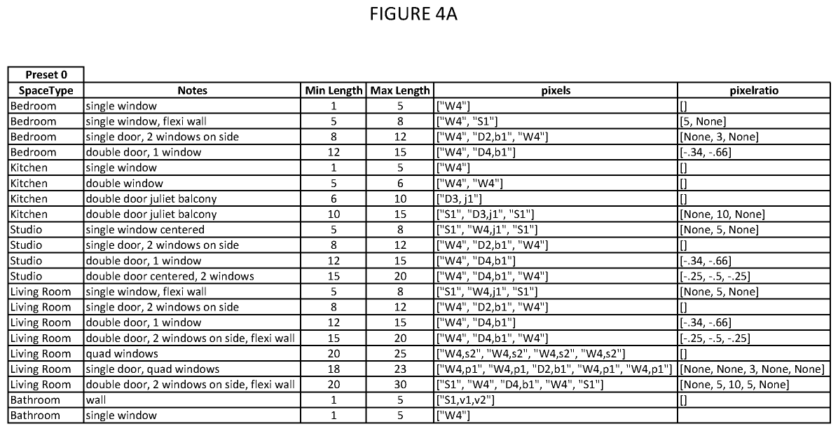

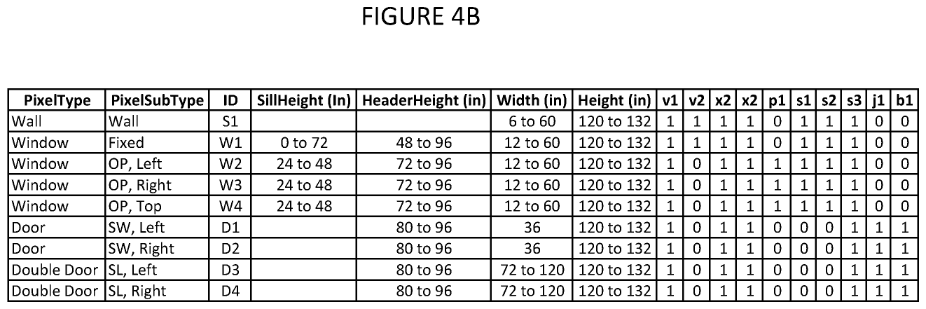

For example, referring now to FIG. 4A, a table of Façade Pixel Configurations according to one embodiment is shown. In this table, each row specifies an individual Façade Pixel Configuration where the first column is the interior space type (e.g., bedroom vs. kitchen vs. studio vs. living room vs. bathroom, as shown), the second column are notes describing the space type (e.g., number of windows, number of doors, type of window or door, etc.), the third column is the minimum length and the fourth column is the maximum length of a Façade Frontage to which the Façade Pixel Configuration is applicable, the fifth column specifies the Façade Pixel Configuration as explained further below, and the sixth column specifies the ratio of the pixel elements for the Façade Pixel Configuration as also explained further below. Further, as indicated in the figure, this table is a set of façade configurations that can be used as a façade design preset, in this case labeled “Preset 0”.

In various embodiments, the Façade Pixel Configurations shown in FIG. 4A are a set of façade configurations comprising walls, doors, windows, etc., predefined by a creator, administrator or designer/user of the Façade Design Generation System 100 of FIG. 1 and stored in Memory Module 140 of FIG. 1. The predefined Façade Pixel Configurations, as stated above, are specified using various façade components such as walls, doors, windows, etc., to be applied to the Façade Frontages as described herein.

Referring now to FIG. 4B, a table showing an example set of such façade components is shown according to one embodiment. In this table, each row specifies a different component where the first column specifies the façade component type (e.g., wall, window, door, double door, etc.), the second column more particularly specifies the façade component type (e.g., wall, fixed window, opening window left, opening widow right, opening window top, etc.), the third column specifies an identifier (“ID”) for each of the facade component types (e.g., S1, W1, W2, W3, W4, D1, D2, D3, D4, etc.), the fourth column specifies the building sill height in inches for the façade component, the fifth column specifies the building header height in inches for the façade component, the sixth column specifies a range in inches of a width of the façade component, the seventh column specifies a range in inches of a height of the façade component, and the remaining columns specify what additional elements (referred to herein as “addons”) can be specified for a given façade component in the Façade Pixel Configurations (e.g., HVAC Intake (“v1”), HVAC Exhaust {v2”), Planter Box (“p1”), Shading Device Right (“s1”), Shading Device Top (“S2”), Shading Device Left (“s3”), Juliet Balcony (“j1”), and Balcony (“b1”), etc.).

It can now be seen that the predefined Façade Pixel Configurations of FIG. 4A specify facade configurations of varying dimensions using the different façade components of FIG. 4B. For example, with reference to the fourth entry in the table of FIG. 4A, the façade configuration for an interior space of a bedroom having a length between the minimum length of 12 feet and a maximum length of 15 feet is specified as “[“W4”, “D4,b1”]” which, according to the IDs of the façade components in FIG. 4B, is a façade configuration of an opening window top (“W4”) and a Double Door Sliding Right with a Balcony (“D4,b1”).

Referring again to FIG. 3, in step 340, a Façade Pixel is instantiated for each Façade Frontage according to the located Façade Pixel Configurations. In particular, in one embodiment and as explained further elsewhere herein, such instantiation is done by Façade Pixel Generator Module 110 of FIG. 1 storing in Memory Module 140 of FIG. 1 each Façade Pixel where the Façade Pixel has been adjusted, as needed, to fit dimensions of the Façade Frontage and according to the Façade Pixel Configuration located for that Façade Pixel.

Using an example of a façade frontage having a defined interior space of a bedroom having a length of 15 feet, searching through the table of FIG. 4A finds a match with a Pixel Façade Configuration of a bedroom between 12 and 15 feet in length, which is specified by the predefined pixel configuration of “[“W4”, “D4,b1”]” as being an opening window top and a door that swings right with a balcony, as was explained above. As can also now be understood, the Façade Pixel for this façade frontage is then instantiated by adjusting the façade pixel as specified by the pixel ratio, the last column shown in the example of FIG. 4A.

Pixel ratio is used to instantiate a Façade Pixel according to the specified length of the façade frontage and as specified in the Pixel Façade Configuration. In one embodiment, pixel ratio is used according to the following formula: a) pixel ratios are defined to suit the range of length of preset; b) if there is at least one negative value in the pixel ratio, it is a ratio from 0.0 to 1.0 (so calculate length value for each value, e.g., with pixel preset pixel ratio values of [−0.4, −0.6] and total length of frontage of 12 feet, the resultant pixel length values are 4.8 feet (0.4*12 feet) and 7.2 feet (0.6*12 feet)); and c) if there is no negative value in the pixel ratio then calculate the length value for each None value (according to the formula (Total Length−Sum)/N) where Sum is the sum of defined values and N is the count of None value (e.g., if preset pixel ratio values=[None, 3, 3, 3, None) and Total Length of frontage is 12 feet then None=(12−(3+3+3))/2=1.5 feet and the resultant pixel length values in feet=[1.5, 3, 3, 3, 1.5]).

Again using the example of a façade frontage having a defined interior space of a bedroom having a length of 15 feet, specified by the predefined pixel configuration of “[W4”, “D4,b1”]”, which as can be seen in the fourth row of the table of FIG. 4A has a defined pixel ratio of “[−0.34, −0.66]” results in being instantiated as a Façade Pixel of a window opening top having a width of 5 feet (=0.34*15 feet) and a door that swings right with a balcony having a width of 10 feet (=0.66*15 feet), thus resulting in a Façade Pixel instantiation of pixels [“W4”, “D4,b1”] and lengths “[5, 10]” for this Façade Frontage (thus “W4” length 5 ft and “D4;b1” length 10 ft) It is to be understood in light of the teachings herein that Façade Pixel instantiation thus specifies pixel configurations and their associated lengths stored together or stored separately and connected using any known data association or linking technique known in the art.

A similar process of locating matches for each of the Façade Frontages in the Façade Pixel Configurations in step 330 and instantiating each of the Façade Pixels for each of them in step 340 is performed.

In step 350, the Façade Pixels instantiated in step 340 are arranged into a Façade Strip, which is the sequence of instantiated Façade Pixels also indicating relevant building floor number for each. In particular, in one embodiment, Façade Pixel Generator Module 110 of FIG. 1 stores in Memory Module 140 of FIG. 1 each of the Façade Pixels instantiated in step 340 as a logical contiguous strip or sequence of Façade Pixels demarcating or notating on which building floor number each Façade Pixel is located. It is to be understood that arranging Façade Pixels as a Façade Strip by storing Façade Pixels as a logical contiguous strip or sequence demarcating building floor number for each Façade Pixel is not limited to storing the instantiated Façade Pixels in contiguous memory locations and, instead, can be done using any known data structure technique for storing a linear collection of data elements such as a linked list, etc., and can be done as part of the instantiation process of step 340.

As now shown and explained, in one embodiment, Façade Pixel Generator Module 110 of FIG. 1, according to step 210 of FIG. 2, and more particularly according to process 300 of FIG. 3, generates a collection of Façade Pixels, using the predefined specifications according to FIGS. 4A and 4B.

It is to be understood that the façade components of FIG. 4B are merely one example of possible façade components and that other façade components may be available for use in other implementations. It is to be further understood that the Façade Pixel Configurations of FIG. 4A may likewise differ in an alternative embodiment. For example, if a different set of façade components is available, a different set of Façade Pixel Configurations may be specified so as to use those different façade components.

In a still further embodiment, the Façade Pixel Configurations of FIG. 4A are treated as one Façade design preset (designated “Preset 0” in the figure) and one or more other Façade design presets may be created for use by the Façade Designer. In such an embodiment, as explained elsewhere herein, the Façade Designer may select a different façade design preset (e.g., “Preset 1”) to be used instead when instantiating the Façade Pixels, thus resulting in Façade Design Generation System 100 automatically generating a different building façade. Selecting a different façade design preset may be based on different façade design presets being designated by building style (e.g., simple, complex, traditional, contemporary, etc.) or may simply be alternatives selectable by the Façade Designer either initially or after Façade Design Generation System 100 has automatically generated one more building façade designs for consideration.

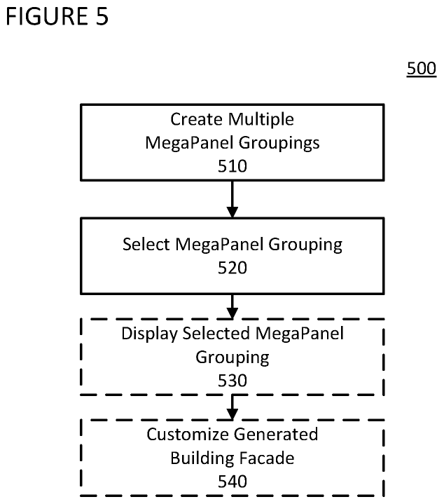

Referring now to FIG. 5, in accordance with one embodiment, a more detailed example of MegaPanel Generator Module 120 of FIG. 1 generating Façade MegaPanels from Façade Pixels according to step 220 of FIG. 2 is shown as process 500. It is to be understood that a MegaPanel, as that term is used herein, is a set or combination of multiple Façade Pixels. In one embodiment, MegaPanels are equivalent to prefabricated building façade panels of the known art however in some instances will be larger than such known building façade panels. While MegaPanels are not limited to any particular size, in general they are larger than a standard 8 foot by 4 foot sheet of plywood, and are thus not easily carried by a single person, yet are small enough to be easily transported to a building site on a flat bed truck, etc. In one embodiment, MegaPanels have a range between 12 and 26 feet in length but are not necessarily limited to that range.

In step 510, multiple groupings of MegaPanels are created from Façade Pixels where each MegaPanel is made up of a set of multiple contiguous Façade Pixels. In one embodiment, MegaPanel Generator Module 120 of FIG. 1 creates multiple groupings of MegaPanels from the Façade Pixels created in step 210 of FIG. 2.

In one embodiment, the present approach seeks to minimize the number of different MegaPanels created in order to maximize uniformity of the created MegaPanels. This is thus an optimization process which aims to improve logistics, component handling, reduces installation time and provides other benefits, as explained further elsewhere herein.

In one embodiment, grouping Façade Pixels into MegaPanels is accomplished using a computer science decision problem called a Subset Sum Problem where, given a multiset of positive integers and a target sum T, a group of all subsets of the numbers is created while keeping positional order of the contiguous Façade Pixels, such that each subset sums to precisely T or close to T with a tolerance threshold (i.e., range). Stated slightly differently, given an ordered set of Façade Pixels with various lengths, the Façade Pixels are grouped such that the sum (of the length) of each group of Façade Pixels matches a target MegaPanel size of, for example, 12 to 25 feet.

For example, given an ordered set of Façade Pixels with sizes (e.g., in feet) of [5,4,3,5,3,4,5,3,4,5,4,3], one resulting grouping into MegaPanels could be [(5,4,3,5,3,4), (5,3,4,5,4,3)] meaning 2 MegaPanels with sizes of [24, 24] (thus 2 unique MegaPanels of 24 feet each, and the most optimized) while an alternative resulting grouping into MegaPanels could be [(5,4,3), (5,3,4), (5,4,3), (5,3,4)] meaning 4 MegaPanels with sizes of [12, 12, 12, 12} (thus also 2 unique MegaPanels of 12 feet each, where each MegaPanel occurs twice, but not the most optimized, at least in a preferred embodiment which considers cost effectiveness, i.e., manufacturing, installation time and cost, as a primary factor).

Two example implementations of grouping a sequence of Façade Pixels into MegaPanels will now be described with reference to associated figures.

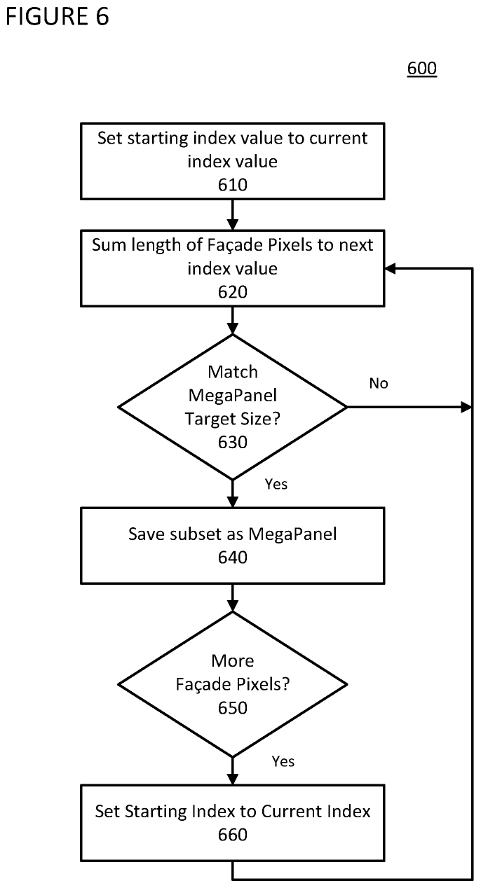

Referring now to FIG. 6, grouping sequential Façade Pixels into MegaPanels is performed according to a first method 600, referred to herein as a forward-checking method, as shown and described.

In step 610, starting with a current index value of zero, a starting index value (e.g., a pointer to the beginning of the sequence of Façade Pixels) is set to be the current index value. In step 620, the sum length of the list of Façade Pixels up to and including a next index value of the current index value plus 1 (thereby incrementing to the next sequential Façade Pixel) is calculated. In step 630, a determination is made regarding whether the sum calculated in step 620 matches (or is within a target threshold range of) the MegaPanel target size (e.g., 25 feet). If the calculated sum does not match (or is not within range of), the process returns to step 620 and the sum length is again calculated by including a next index value of the current index value plus 1 (thereby further incrementing to the next sequential Façade Pixel). Step 630 is then repeated to again determine whether the calculated sum matches (or is within a target threshold range of) the MegaPanel target size. Once the calculated sum matches (or is within range of) the MegaPanel target size, the process continues to step 640 where the starting index value and the current index value are saved as a subset of Façade Pixel values defining a MegaPanel. In step 650, a determination is made regarding whether there are any more Façade Pixels to be considered for grouping into MegaPanels. If there are, then the process proceeds to step 660 where the starting index value is set to the current index value (incremented as described above) and the process then returns to step 620 to continue evaluating Façade Pixels for grouping into MegaPanels, otherwise the process concludes having completed generating MegaPanels from the Façade Pixels.

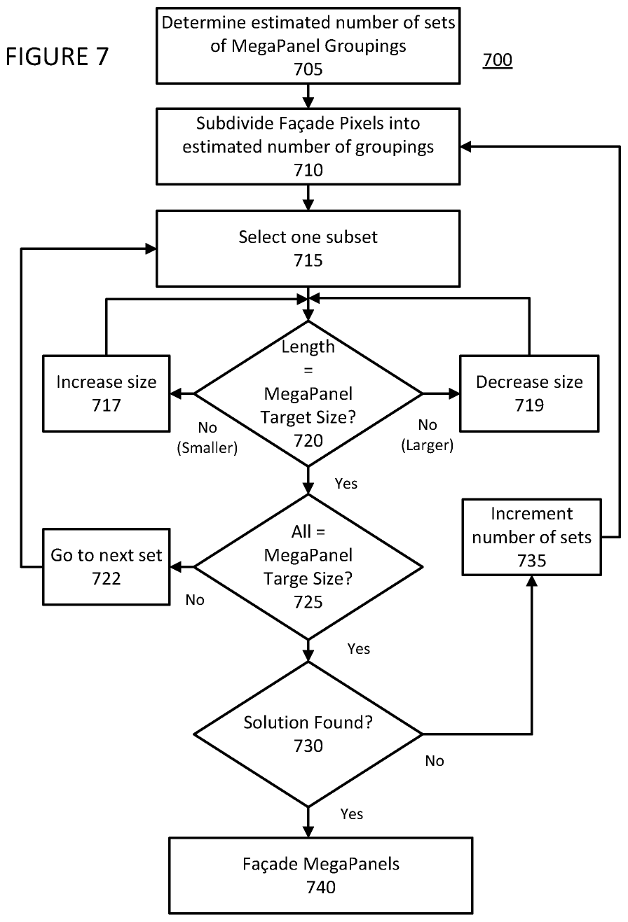

Referring now to FIG. 7, grouping sequential Façade Pixels into MegaPanels is performed according to a second method 700, referred to herein as a partitioning problem approach, as shown and described.

In step 705, an estimated number of sets (N) of MegaPanel groupings is determined by dividing the total sum (i.e., length) of the set of sequential Façade Pixels by a target sum (e.g., 25 feet). In step 710, the set of sequential Façade Pixels are subdivided into N subsets of equal size. In step 715, one of the subsets of Façade Pixels is selected. In step 720, a determination is made regarding whether a total length of the selected subset matches (or is within a target threshold range) of the MegaPanel target size (e.g., 25 feet). If smaller, then the Façade Pixel subset size is increased in step 717 and step 720 is repeated. If larger, then the Façade Pixel subset size is decreased in step 719 and step 720 is repeated. This continues until the determination made in step 720 is that the Façade Pixel subset size matches (or is within a target threshold range) of the MegaPanel target size. The process continues to step 725 where a determination is made regarding whether all of the Façade Pixel subsets of the current subset size match (or are within the target threshold range) of the MegaPanel target size. If any one of the remaining Façade Pixel subsets does not match (or is not within the target threshold range) of the MegaPanel target size, the process continues to a next Façade Pixel subset, in step 722, by returning to step 715 to select that next Façade Pixel subset and repeat the process with respect to that newly selected Façade Pixel subset. If, however, all of the remaining Façade Pixel subsets match (or are within the target threshold range of) the MegaPanel target size, it is determined in step 730 that a MegaPanel grouping solution has been found resulting in a grouping of sequential Façade Pixels into MegaPanels in step 740, otherwise the process proceeds to step 735 where the number of Façade Pixel subsets is incremented by one and then, by returning to step 710, where the entire set of sequential Façade Pixels is subdivided into N+1 subsets of equal size and the process continues.

As has thus been shown by example, more than one grouping of Façade Pixels into MegaPanels is created in one embodiment, and by various alternative methods.

Referring again to FIG. 5, in step 520, one of the groupings of MegaPanels created in step 510 is chosen or selected as being an optimized grouping of MegaPanels based, in a preferred embodiment, on cost effectiveness or other criteria as explained elsewhere herein. According to one embodiment, the selection made in step 510 is made by scoring the groupings of MegaPanels.

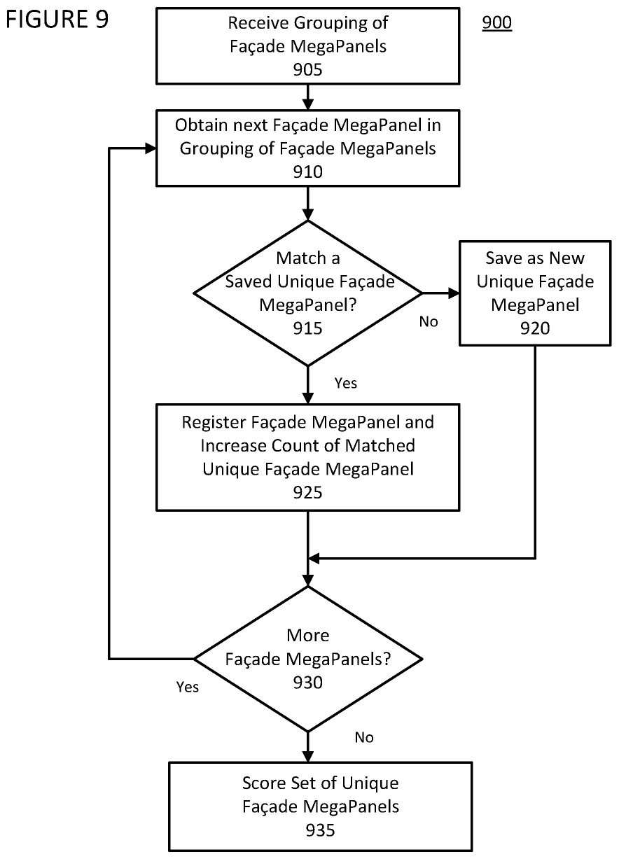

Referring now to FIG. 9, a method 900 to identify and score a set of unique Façade MegaPanels in a grouping of MegaPanels according to one embodiment will now be explained.

In step 905, a grouping of Façade MegaPanels (e.g., one of those created as explained with reference to FIG. 6 or FIG. 7) is received. In step 910, a next Façade MegaPanel from the grouping of Façade MegaPanels received in Step 905 is obtained, which means obtaining the first Façade MegaPanel in the grouping of Façade MegaPanels the first time method 900 is run for that grouping of Façade MegaPanels.

In step 915, a determination is made regarding whether the obtained Façade MegaPanel matches any Unique Façade MegaPanels already identified in the grouping of Façade MegaPanels. If the obtained Façade MegaPanel does not match any identified Unique Façade MegaPanel from the grouping of Façade MegaPanels in step 915, this means the obtained Façade MegaPanel is a Unique Façade MegaPanel in which case, in step 920, it is saved as a new Unique Façade MegaPanel, along with initializing an associated counter to one.

Conversely, if the obtained Façade MegaPanel does match an identified Unique Façade MegaPanel from the grouping of Façade MegaPanels in step 915, this means the obtained Façade MegaPanel is not a Unique Façade MegaPanel in which case, in step 925, the matching obtained Façade MegaPanel is registered (i.e., notated) to indicate the match and the counter for that matched Unique Façade MegaPanel is increased by one thereby indicating that another instance of that Unique Façade MegaPanel exists in the grouping of Façade MegaPanels.

A determination is made, in step 930, regarding whether there are any more Façade MegaPanels in the grouping of Façade MegaPanels, and if so the process returns to step 910 to obtain the next Façade MegaPanel in the grouping of Façade MegaPanels and the process continues.

Conversely, if the determination made in step 930 is that there are no more Façade MegaPanels in the grouping of Façade MegaPanels then all unique Façade MegaPanels in the grouping of Façade MegaPanels, and the number of each, has been determined. The process then proceeds to step 935 where the set of unique Façade MegaPanels in the grouping of Façade MegaPanels is scored as will now be explained.

As will be understood in light of the teachings herein, scoring a set of unique Façade MegaPanels in a grouping of Façade MegaPanels can vary dependent upon differing criteria. As will also be understood in light of the teachings herein, while Façade Pixel lengths constrain MegaPanel size, the type of Façade Pixels in a given MegaPanel determines its uniqueness (e.g., a subset of Façade Pixels [“W4”,“W4”,“W4”,“W4”,“D4,b1”] is not identical to a subset of Façade Pixels [“W3”,“W4”,“W4”,“W4”,“D4,b1”], each as was explained with reference to FIGS. 4a and 4b, even if the subsets have the same length). As such, consider the following example of associated costs and sets of Unique Façade MegaPanels.

In this example, the manufacturing cost of a large (longer) MegaPanel is $10 while that of a small (shorter) MegaPanel is $7. Further, in this example, the delivery cost of a large (longer) MegaPanel is $10 while that of a small (shorter) MegaPanel is $2.

In a first set of Unique Façade MegaPanels, there are 2 subsets of Façade Pixels with 2 unique subsets such that 2 large MegaPanels cost 2*$10=$20 to make and 2*$10=$20 to transport for a total cost of $20+$20=$40.

In a second set of Unique Façade MegaPanels there are 4 subsets of Façade Pixels with 4 unique subsets such that 4 small MegaPanels cost 4*$7=$28 to make and 4*$2=$8 to transport for a total cost of $28+$8=$36.

In a third set of Unique Façade MegaPanels there are 4 subsets of Façade Pixels with 2 unique subsets such that 1 large MegaPanel costs 1*$10=$10 to make and 1*$10 =$10 to transport while 2 small MegaPanels cost 2*$7=$14 to make and 2*$2=$4 to transport for a total cost of $10+$10+$14+$4=$38.

If the criterion for scoring is minimizing uniqueness (or stated conversely, maximizing uniformity), then the most optimized solution is the first set of Unique Façade MegaPanels because it has the lowest number of unique subsets, namely 2 in this example. However, if the criterion for scoring is minimizing cost, then the most optimized solution is the second set of Unique Façade MegaPanels because it has the lowest cost, namely $36 in this example.

As is thus now evident, scoring a set of unique Façade MegaPanels in a grouping of Façade MegaPanels is an optimization process that varies dependent upon which criteria is specified, which criteria is itself dependent upon underlying factors such as manufacturing and transportation costs. Specifying such criteria, which can be predefined in the system of the present approach and/or be user-selectable in a given implementation, thus directs selection between different MegaPanel groupings in step 520, with reference again to FIG. 5.

Continuing with reference to FIG. 5, in step 530, an optional step as indicated by the dashed line, the selected optimum grouping of MegaPanels is used by Façade Design Generation System 100 to display to the façade designer on a display device (not shown) the resulting façade design. Such display provides a visual indication to the façade designer what the automatically generated façade design looks like.

In step 540, also an optional step as indicated by the dashed line, Façade Design Generation System 100 facilitates customization by the façade designer. In one embodiment, such customization is performed by the façade designer selecting one or more of the Façade Components, Façade Pixels, Façade Design preset(s), and/or MegaPanels and directing the system (e.g., via a graphical user interface or other known computer interactive means) to alter the generated façade (e.g., adding balconies, awnings, or other design elements, as desired). As a result, the present system repeats those portions of automatic façade generation as are needed to incorporate the façade designer's changes, thereby defining any new Façade Pixels and/or creating any new MegaPanels as needed according to the approach described and shown herein.

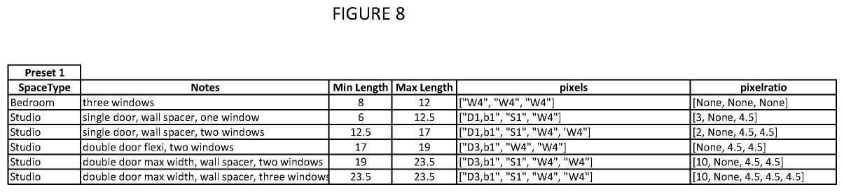

A further example of generating a building façade design according to one embodiment of the present approach will now be shown and described. In this example, included in the system is a Façade Design Preset #1 that has design goals of comfortable living, maximizing façade openings, and minimizing costs of window production. To meet these goals, the following strategies are employed in this façade design preset: 1) each living room has one balcony; 2) windows are placed on all façade frontages for living room and bedroom spaces; 3) windows are all the same width (e.g., 4.5 feet) and as many windows as possible are used; and, 4) walls are used as a flexible Façade Pixel to adjust for variations in frontage length. An example of at least a portion of a Pixel Configuration according to Façade Design Preset #1 can be seen in FIG. 8, as further described below.

According to the process described above with reference to FIG. 3 and step 330, when the Façade Frontages are processed the system will search for matching Pixel Configurations. For example, according to the default Façade Preset #0, referring again to FIG. 4A, and with a defined interior space of a bedroom having a Façade Frontage length of 12 feet, the matching defined configuration is a single door with two windows on the side. This results in 3 Façade Pixels with a sequence of [(“W4”, D2,b1”, W4)]. Pixel ratio then determines how to distribute those pixels, with value [None, 3, None], meaning that the door is of a static size, and the sizes of the windows are flexible. So, a 12 foot Façade Frontage length results in sizes of [4.5, 3, 4.5] where window “W4” is 4.5 feet wide, door “D2,b1” is 3 feet wide, and window “W4” is 4.5 feet wide.

This configuration thus generates a 4.5 foot wide window, a 3 foot wide door (with a balcony), and a 4.5 foot wide window at this bedroom frontage having a total length of 12 feet. However, should the façade designer instead select Façade Design preset #1, perhaps because it better fits with their design goals, then a different matching Pixel Configuration would be found. Having selected Façade Design preset #1, with reference to the first row in FIG. 8, would instead result in a façade frontage of three windows, distributed evenly, equating to three “W4” window pixels of 4 feet each.

As has now been explained, the present approach automatically generates a building façade design given a set of building design parameters. Further, the present approach can automatically generate a different building façade design given a different set of building design parameters and can do so without necessarily having to repeat all of the operations performed when generating a previous building façade design. Still further, the present approach can automatically generate a different building façade design given a different preset selection. This provides the ability to realize different building designs in essentially real-time thus allowing alternatives to be considered. Further still, the present approach can be performed not only by an experienced building façade designer but also by an inexperienced or non-professional person to design an optimized building façade.

The primary example described herein is the generation of a building façade design for an apartment building. However, it is to be understood in light of the teachings herein that the present approach is equally applicable to any type of building that is to contain a mix of different unit types with a defined width (or length). As such, the present approach can be used to generate a building façade design for a condominium building, an office building, a hotel, a hospital, a parking structure, or any other residential or commercial structure. Further, it is to be understood that the approach described herein is agnostic to and therefore not dependent upon nor necessarily use any interior features (e.g., walls, etc.) of the units, whether specified or not, in generating a building façade design.

The disclosed system and method has been explained above with reference to several embodiments. Other embodiments will be apparent to those skilled in the art in light of this disclosure. Certain aspects of the described method and apparatus may readily be implemented using configurations or steps other than those described in the embodiments above, or in conjunction with elements other than or in addition to those described above. It will also be apparent that in some instances the order of steps described herein may be altered without changing the result or performance of all of the described steps.

There may be a single computing system, server or processor, or multiple computing systems, servers or processors to implement the system and perform the different functions described herein. One of skill in the art will appreciate how to determine which and how many of each will be appropriate for a specific intended application.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

These and other variations upon the embodiments described and shown herein are intended to be covered by the present disclosure, which is limited only by the appended claims.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for generating an optimized building façade design, the method comprising:
generating, by a façade pixel generator module, a collection of façade pixels, wherein each façade pixel in the collection of façade pixels defines a set of façade components; and
generating, by a megapanel generator module, a set of defined megapanels, wherein each defined megapanel in the set of defined megapanels comprises a different combination of the generated façade pixels.

2. The method of claim 1, further comprising:
displaying, by a display and customization module, the building façade design using the generated set of defined megapanels;
receiving a user input specifying a change to the generated set of defined megapanels; and
displaying, by the display and customization module, the building façade design using the generated set of defined megapanels incorporating the specified change to the generated set of defined megapanels.

3. The method of claim 1 wherein generating, by the façade pixel generator module, a collection of façade pixels, wherein each façade pixel in the collection of façade pixels defines a set of façade components, comprises:
obtaining a building façade boundary of the building for which the building façade design is being generated;
dividing the façade boundary into façade frontages according to defined interior spaces of the building for which the building facade design is being generated;
locating a façade pixel configuration for each façade frontage by searching a set of predefined façade pixel configurations and finding a matching façade pixel configuration for each of the façade frontages;
instantiating each located façade pixel configuration for each façade frontage by adjusting, as needed, each façade pixel configuration to fit dimensions of the façade frontage according to the façade pixel configuration located for that façade pixel; and,
arranging the instantiated façade pixels into a façade strip.

4. The method of claim 3 wherein the set of predefined façade pixel configurations is one of multiple, user-selectable, façade design presets.

5. The method of claim 1 wherein generating, by a megapanel generator module, a set of defined megapanels, wherein each defined megapanel in the set of defined megapanels comprises a different combination of the generated façade pixels, comprises:
creating multiple groupings of megapanels wherein each megapanel comprises a set of multiple contiguous façade pixels; and
selecting one megapanel grouping from the multiple megapanel groupings.

6. The method of claim 5 wherein creating multiple groupings of megapanels is accomplished using a Subset Sum Problem approach.

7. The method of claim 6 wherein creating multiple megapanel groupings is accomplished using a Subset Sum Problem approach further comprises using a forward-checking method.

8. The method of claim 6 wherein creating multiple megapanel groupings is accomplished using a Subset Sum Problem approach further comprises using a partitioning problem approach.

9. The method of claim 5 wherein selecting one megapanel grouping from the multiple megapanel groupings is based on a calculated score for each of the multiple megapanel groupings.

10. The method of claim 9 wherein the calculated score for each of the multiple megapanel groupings is based on megapanel manufacturing and delivery cost.

11. The method of claim 9 wherein the calculated score for each of the multiple megapanel groupings is based on megapanel uniqueness.

12. A system for generating an optimized building façade design, the system comprising:
a façade pixel generator module configured to generate a collection of façade pixels, wherein each façade pixel in the collection of façade pixels defines a set of façade components; and
a megapanel generator module configured to generate a set of defined megapanels, wherein each defined megapanel in the set of defined megapanels comprises a different combination of the generated façade pixels.

13. The system of claim 12, further comprising a display and customization module, the display and customization module configured to:
display the building façade design using the generated set of defined megapanels;
receive a user input specifying a change to the generated set of defined megapanels; and
display the building façade design using the generated set of defined megapanels incorporating the specified change to the generated set of defined megapanels.

14. The system of claim 12, wherein the façade pixel generator module configured to generate a collection of façade pixels, wherein each façade pixel in the collection of façade pixels defines a set of façade components, is further configured to:
obtain a building façade boundary of the building for which the building façade design is being generated;
divide the façade boundary into façade frontages according to defined interior spaces of the building for which the building facade design is being generated;
locate a façade pixel configuration for each façade frontage by searching a set of predefined façade pixel configurations and finding a matching façade pixel configuration for each of the façade frontages;
instantiate each located façade pixel configuration for each façade frontage by adjusting, as needed, each façade pixel configuration to fit dimensions of the façade frontage according to the façade pixel configuration located for that façade pixel; and,
arrange the instantiated façade pixels into a façade strip.

15. The system of claim 14 wherein the set of predefined façade pixel configurations is one of multiple, user-selectable, façade design presets.

16. The system of claim 12 wherein the megapanel generator module configured to generate a set of defined megapanels, wherein each defined megapanel in the set of defined megapanels comprises a different combination of the generated façade pixels, is further configured to:
create multiple groupings of megapanels wherein each megapanel comprises a set of multiple contiguous façade pixels; and
select one megapanel grouping from the multiple megapanel groupings.

17. The system of claim 16 wherein the megapanel generator module configured to create multiple groupings of megapanels is configured to create the multiple groupings of megapanels using a Subset Sum Problem approach.

18. The system of claim 17 wherein the megapanel generator module configured to create multiple groupings of megapanels using a Subset Sum Problem approach is further configured to use a forward-checking method.

19. The system of claim 17 wherein the megapanel generator module configured to create multiple groupings of megapanels using a Subset Sum Problem approach is further configured to use a partitioning problem approach.

20. The system of claim 16 wherein the system further configured to select one megapanel grouping from the multiple megapanel groupings is further configured to make the selection based on a calculated score for each of the multiple megapanel groupings.

21. The system of claim 20 wherein the calculated score for each of the multiple megapanel groupings is based on megapanel manufacturing and delivery cost.

22. The system of claim 20 wherein the calculated score for each of the multiple megapanel groupings is based on megapanel uniqueness.
